(19) United States
(12) Patent Application Publication
(10) Pub. No.: US 2024/0239069 A1
(43) Pub. Date: Jul. 18, 2024

(54) METHOD FOR PRODUCING A VULCANIZING MOLD AND VULCANIZING MOLD PRODUCED ACCORDING TO THIS METHOD

(71) Applicant: Continental Reifen Deutschland GmbH, Hannover (DE)

(72) Inventors: Nicholas Hoppe, Wunstorf (DE); Jürgen Dzick, Seelze (DE)

(73) Assignee: Continental Reifen Deutschland GmbH, Hannover (DE)

(21) Appl. No.: 18/562,573

(22) PCT Filed: Nov. 18, 2021
(86) PCT No.: PCT/DE2021/200192

§ 371 Date: Nov. 20, 2023

(30) Foreign Application Priority Data
Jun. 1, 2021 (DE) 10 2021 205 576.1

(51) Int. Cl. B29D 30/06; B29C 33/38

(52) U.S. Cl. CPC B29D 30/0606; B29C 33/3842; B29D 2030/0613

(57) ABSTRACT

A method for producing a vulcanizing mold for vehicle tires, in which the vulcanizing mold has radially on the inside cast mold surfaces of a mold material with mold projections for forming cuts in the tread profile of the vehicle tire to be manufactured. The mold projections are formed by in each case first providing a core of a metal of higher strength than the mold material and then coating the core at least partially with the mold material during the casting of the mold surfaces. A corresponding vulcanizing mold is also specified.

### CROSS-REFERENCE TO RELATED APPLICATIONS

The present application is a National Stage Application under 35 U.S.C. § 371 of International Patent Application No. PCT/DE2021/200192 filed on Nov. 18, 2021, which claims priority from German Patent Application No. 10 2021 205 576.1 filed on Jun. 1, 2021, the disclosures of which are herein incorporated by reference in their entireties.

### TECHNICAL FIELD

The invention relates to a method for producing a vulcanizing mold for vehicle tires, which has radially on the inside mold surfaces of a cast mold material with mold projections for forming cuts in the tread profile of the vehicle tire to be manufactured.

The invention also relates to a vulcanizing mold produced according to such a method for the manufacture of vehicle tires.

### BACKGROUND

Vulcanizing molds for vehicle tires consist of, among other things, mold segments whose mold surfaces together form the radially outer surface of the tire to be manufactured, such as the tread, the shoulder area, the sidewalls and the bead area.

The mold segments of the vulcanizing mold are made of metal, usually of steel or aluminum. While mold surfaces produced from steel are often machined from a solid material, mold surfaces produced from aluminum are usually produced in a casting process. A person skilled in the art is sufficiently aware of center-split vulcanizing molds and segmented vulcanizing molds.

The unvulcanized green tire blank is hot-pressed in the vulcanizing mold and transformed into its final rubber-elastic state by means of rubber cross-linking reactions. The vehicle tire obtains its tread-profile and sidewall design by the corresponding negative contour of the mold surfaces with corresponding mold projections for forming cuts in the tread profile.

Such cuts in the tread profile may for example delimit individual tread bars. In particular, winter tires also have fine cuts, or sipes, in the profile elements of the tread, which give the tire advantageous properties on winter road surfaces. These cuts can sometimes have complex three-dimensional shapes, so that the production of the corresponding mold projections in the mold surface of the vulcanizing mold is correspondingly complex.

Conventional casting molds, for example of aluminum, with cast mold projections, have material-related strength limitations that restrict the production-related implementation of functional mold structures, especially fine mold projections.

It is also known in the prior art to produce such mold projections separately from the other mold surfaces of the vulcanizing mold. In order for instance to make fragile structures, such as sipe-forming structures, suitable for use in a casting mold for tire production, they are produced from other materials with different mechanical characteristics, for example from sheet steel, and cast into the mold surface with a formed-on anchoring part under the surface. The casting-in creates an interlocking engagement, but not a material bond. In addition, such sipe blades are very difficult to produce, especially in the case of 3-dimensional sipes. Such cast-in, separately produced mold projections are also subject to greater tolerances in terms of manufacturing technology than directly cast structures.

This raises the problem, especially in the case of very narrow and high mold projections, which go to the full tread-profile depth, that cast structures are within the permissible height tolerance, but have only low durability and, on the other hand, separately created steel inserts for forming the mold projections have good durability, but are often outside the height tolerances.

From DE 10 2012 102 322 A1 it has also been proposed to produce the mold projections in a rapid prototyping process, for example 3D printing or a laser sintering process, and subsequently introduce the mold projections produced in this way into the cast mold surface. However, both the production of the mold projections and the subsequent introduction into the cast mold surface are complex, which seems to be in need of improvement.

### SUMMARY

The object of the invention is therefore to propose a method for producing a vulcanizing mold and a correspondingly produced vulcanizing mold which overcomes the disadvantages of the prior art.

To solve the stated problem, the invention proposes the design of a method according to the features of patent claim 1.

In addition, a corresponding vulcanizing mold according to the features of patent claim 7 is also proposed for solving the stated problem.

Advantageous configurations and developments of the invention are the subject of the dependent claims.

The method proposed in the context of the invention for producing the vulcanizing mold provides that, for forming a mold projection, first a core of a metal of higher strength than the mold material is provided and then the core is at least partially coated with the mold material during the casting of the mold surfaces, whereby, at the same time as the forming of the mold surfaces, the mold projections are formed from the cast mold material with the inner core.

Such mold projections of the cast mold material with an inner core of a metal of higher strength which according to the invention are formed in the vulcanizing mold are distinguished by particularly high mechanical durability and by reliable compliance with the required height tolerances, even in the case of very narrow and/or complex cross-sectional designs. At the same time, the production of the vulcanizing mold is significantly simplified.

It goes without saying that, by the method according to the invention, at least one mold projection is produced, in particular with a complex or narrow and high shape. Nevertheless, mold projections of a conventional design may also be combined with the mold projections produced in a mold surface by the method according to the invention.

According to the invention, the inner mold surface of the vulcanizing mold including the existing mold projections for forming the cuts in the tread profile of vehicle tires to be manufactured is completely formed from the cast mold material, but the mold projections are provided with a reinforcing core of metal in the manner of a reinforcement and are at least partially enclosed by the cast mold material and integrated in the cast mold surface.

According to a proposal of the invention, the core is completely coated with and encased by the mold material so that it is no longer visible when viewing the mold surfaces.

According to a further proposal of the invention, the core has a multiplicity of apertures, which are penetrated by the mold material during the casting process. In this way, an intimate interlocking connection of the mold material forming the contour of the mold protrusions with the inner core is created, since a material bond cannot be produced in every case between the core of metal of higher strength and the mold material.

According to a proposal of the invention, the apertures may be produced by a multiplicity of bores being formed in the core, into which the mold material can penetrate during the coating of the core.

Alternatively, the core may also have a grid-like structure or any other open structure or geometry containing the apertures. Such a configuration is advantageous in particular if the wall thickness of the coated mold material surrounding the core is very small. Otherwise, there is a risk that the molten mold material will prematurely solidify on the core during casting and that the structure of the core will not be completely penetrated by the melt. When the core is formed from a grid-like structure, however, the multiplicity of apertures present ensures that the molten cast mold material completely fills the core. This also improves the connection of the core to the surrounding mold material.

As a material for forming the core, steel in particular is considered to be suitable, the cast mold material preferably being selected in a known manner on the basis of aluminum or a corresponding alloy.

According to a further proposal of the invention, the core may for example be produced from a bent sheet-metal blank or else in an additive process, for example from a laser-sintered material or a material shaped by means of a 3D printer. In any case, the design of the cores must allow for the expected loads and provide a corresponding structural design, if necessary including mathematical topology optimization models.

Considered in particular for the production of the core from a laser-sintered material are metals and their alloys that can be processed by means of laser sintering, such as steels, aluminum, titanium, as well as other sintered metals and sintered materials such as ceramics and alumina.

Attached to, for example welded on, the core, which is partially or completely encased by mold material, may be, if required, a sipe blade, at least a region of which is also not covered with the mold material, in order to replicate even the finest structures positionably with high precision in the mold projection.

In particular when the cores are produced in an additive process, simulated and optimized structures with complex geometry can be produced with the greatest accuracy directly from the data calculated in the model.

Moreover, each individual core may also be provided, if required, with further features, for example formed-on stiffening ribs, along its axes of extent to increase the stiffness of the connection.

### BRIEF DESCRIPTION OF THE DRAWINGS

Further configurations and details of the invention are explained below in exemplary embodiments with reference to the drawing, in which:

FIG. 1 shows a vulcanizing mold for vehicle tires according to the invention in a schematic representation;

FIG. 2 a shows the cross section through a mold projection in a first embodiment of the invention;

FIG. 2 b shows the longitudinal section through the mold projection according to FIG. 2 a;

FIG. 3 a shows the cross section through a mold projection in a second embodiment of the invention;

FIG. 3 b shows the longitudinal section through the mold projection according to FIG. 3 a;

FIG. 4 a shows the cross section through a mold projection in a third embodiment of the invention;

FIG. 4 b shows the longitudinal section through the mold projection according to FIG. 4 a;

FIG. 5 shows the cross section through a mold projection in a fourth embodiment of the invention;

FIG. 6 a shows the plan view of a sixth embodiment of the invention;

FIG. 6 b shows a section through the embodiment according to FIG. 6 a;

FIG. 7 a shows the plan view of a seventh embodiment of the invention;

FIG. 7 b shows a section through the embodiment according to FIG. 7 a.

### DETAILED DESCRIPTION

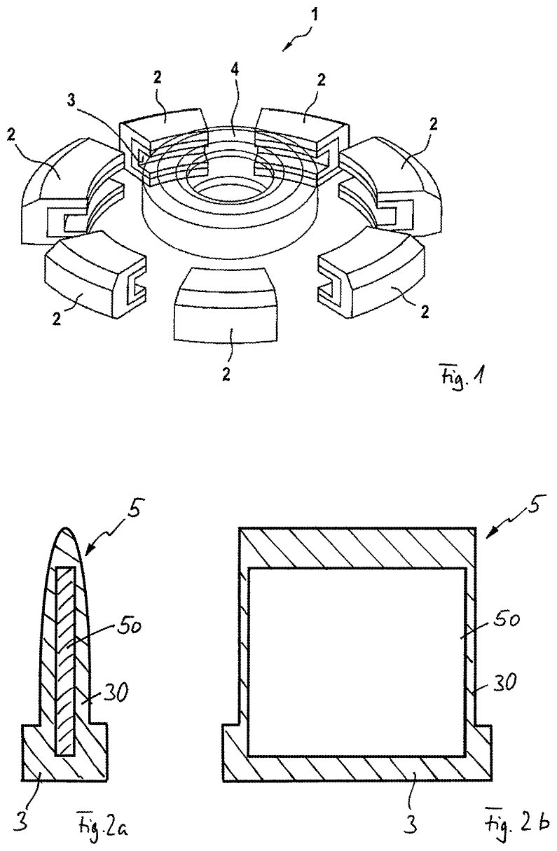

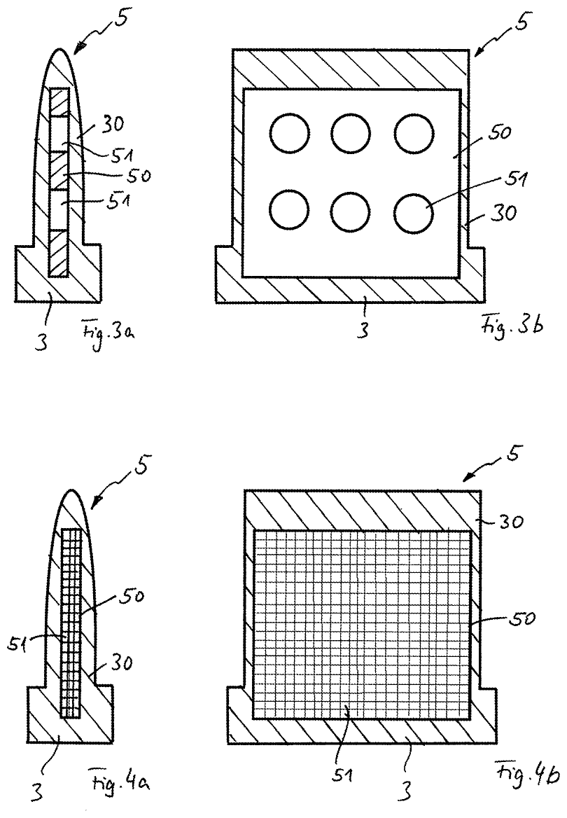

FIG. 1 illustrates in a greatly simplified schematic representation a vulcanizing mold 1 for the production of an indicated vehicle tire 4, which is inserted into the vulcanizing mold 1 as a green, unvulcanized tire blank and is hot-pressed in the vulcanizing mold 1 in a manner known per se, it being transformed into its final rubber-elastic state by means of rubber cross-linking reactions. For this purpose, the vulcanizing mold 1 consists of a multiplicity of openable and closable mold segments 2, which have on their radial inner side facing the vehicle tire 4 cast mold surfaces 3 of a mold material 30, for example aluminum. These mold surfaces have a surface profiling not reproduced in detail in the representation according to FIG. 1 with protruding mold projections 5, which represent the negative shape of the positive shape desired in the vehicle tire 4 to be produced, with tread bars, sipes, inscriptions, etc. In particular, in the case of mold projections 5 that are very fine and reach to the full tread-profile depth, which are shown in various embodiments of the representations according to FIGS. 2 a to 5, the strength and dimensional accuracy of the same have to meet the highest requirements.

With regard to the representations of the mold projections 5 according to FIGS. 2 a to 5 explained below, it should first be noted that these figures only illustrate the structure schematically and by way of example, without reverting to the real, sometimes complex, three-dimensional design for reasons of simplification.

As can be seen from the representation of a first embodiment of a mold projection 5 according to FIGS. 2 a and 2 b, a core 50 of a metal of higher strength than the mold material 30 is initially provided for forming the projection, for example a blank of a steel sheet. Subsequently, during the production of the mold surface 3 produced from the mold material 30, in particular aluminum, by the casting process, the core 50 is completely coated with and encased by the cast mold material 30, so that the mold material 30 forms the outer contour and thus the desired geometry of the mold projection 5, and the core 50 is arranged internally in the manner of a reinforcement. The mold projection 5 therefore rises up integrally out of the cast mold surface 3 and has the highest form tolerance and dimensional tolerance due to the coating of the core 50 of the cast mold material 30, at the same time the internally arranged steel core 50 ensuring particularly high strength and mechanical load-bearing capacity of the mold projection 5.

According to the representation in FIGS. 3 a and 3 b, the core 50 may also have a multiplicity of apertures 51, which may be formed for example by introducing bores into the core 50. Although not explicitly shown in the representations according to FIGS. 3 a and 3 b, in the formation of the coating of the core 50 with the mold material 30 these apertures 51 are completely filled by this material, whereby an intensive interlocking engagement is established between the core 50 and the mold material 30, which encases and coats the core 50.

A similar effect can also be produced by the core 50 according to the exemplary embodiment of FIGS. 4 a and 4 b having a grid structure or comparable open structure, in which the core 50 is for example produced from a steel mesh. Such a grid structure also defines a multiplicity of apertures 51, which are filled by the mold material 30 melted in liquid form during the casting of the mold surfaces 3. Moreover, in the case of very low wall thicknesses of the mold material 30 coating the core 50, such a configuration has the effect of avoiding that the molten mold material 30 solidifies prematurely on the core 50 and the core 50 is not completely filled with mold material 30.

According to the exemplary embodiment in FIG. 5, to increase the stiffness of its connection, the core 50 may also be formed with further protruding stiffening elements, for example externally formed-on stiffening ribs 52, along its axes of extent.

The cores 50 encased by the mold material 30 in the exemplary embodiments described above may for example be formed from a sheet metal blank, which if necessary is cut and bent into a desired shape, or else produced in an additive process, for example by means of laser sintering or 3D printing in accordance with a calculated design.

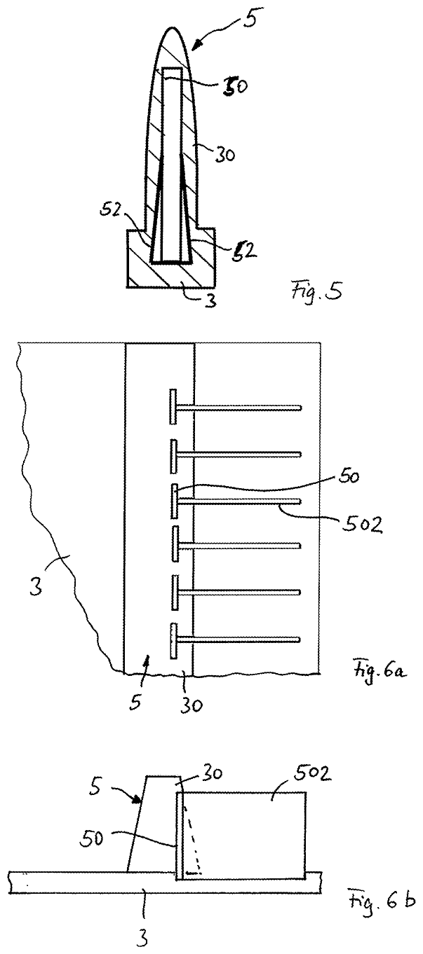

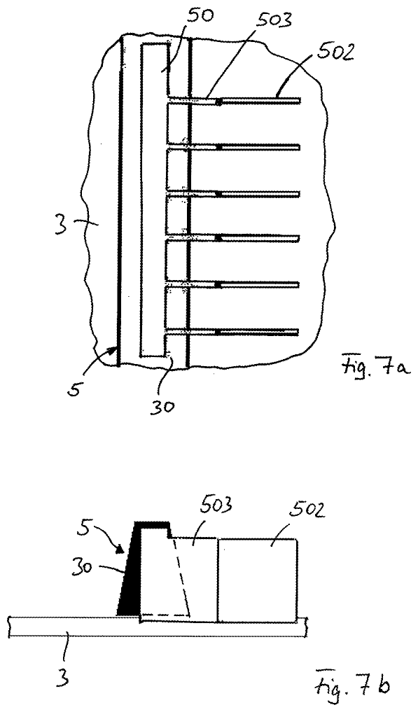

FIGS. 6 a and 6 b show a further embodiment of the vulcanizing mold. In a mold projection 5 cast from the mold material 30 in the manner of a rib, a multiplicity of cores 50 are completely cast in, i.e. they are completely encased by the mold material 30 in the casting process. Furthermore, a sipe blade 502 is attached to each of the cores 50, for example welded on, approximately in a T-shaped manner. The attachment already takes place before the casting in of the core 50 in the mold material. A region of the sipe blade 502 attached in such a way to the cast-in core 50 is led out from the formed rib 503 after the casting of the mold material 30 and is not encased by the mold material 30 in this led-out region. As a part of the mold projection 5, it replicates even the finest sipe structures in a precisely positioned manner.

In FIGS. 7 a and 7 b, a further embodiment of the vulcanizing mold is shown. In this case, the core 50 is arranged within the mold projection 5 cast from the mold material 30, but has a plurality of legs 503 protruding at an angle, which protrude with their free end from the mold material 30, so that the core 50 is not encased by mold material 30 in this partial region of its legs 503. Attached to these free ends of the legs 503, for example welded on, are sipe blades 502 not covered by the mold material 30, in order as part of the mold projection 5 to replicate finest structures.

With the method described above and the vulcanizing mold produced by it, in particular mold projections with a narrow transverse void including chamfers can be produced with high precision and increased durability.

It goes without saying that the method described above can also be used for other applications in mold making.

### LIST OF REFERENCE SIGNS

1: Vulcanizing mold
2: Mold segment
3: Mold surfaces
4: Vehicle tire
5: Mold projection
30: Mold material
50: Core
51: Aperture
52: Stiffening rib
502: Sipe blade
503: Leg

1. A method for producing a vulcanizing mold for vehicle tires, wherein the vulcanizing mold has radially on the inside cast mold surfaces of a mold material with mold projections for forming cuts in the tread profile of the vehicle tire to be manufactured, wherein, for forming the mold projections, a core of a metal of higher strength than the mold material is provided and is at least partially coated with the mold material during the casting of the mold surfaces.

2. The method as claimed in claim 1, wherein the core is completely coated with and encased by the mold material.

3. The method as claimed in claim 1, wherein at least one sipe blade, at least a region of which is not coated with the mold material, is attached to the core.

4. The method as claimed in claim 1, wherein the mold material is used on the basis of aluminum and the core is formed from steel.

5. The method as claimed in claim 1, wherein the core has a multiplicity of apertures, which are penetrated by the mold material.

6. The method as claimed in claim 5, wherein the apertures are formed in the form of bores in the core or the core has a grid-like structure containing the apertures.

7. The method as claimed in claim 1, wherein the core is produced from a sheet metal blank or in an additive process.

8. A vulcanizing mold for the manufacture of vehicle tires, which has radially on the inside mold surfaces with mold projections of a cast mold material, the mold projections being configured for forming cuts in the tread profile of the vehicle tire to be manufactured, wherein the mold projections each have a core of a metal of higher strength than the mold material which is at least partially coated with the mold material.

9. The vulcanizing mold as claimed in claim 8, wherein the core is completely coated with and encased by the mold material.

10. The device as claimed in claim 9, wherein at least one sipe blade protruding from the mold material is attached to the core.

11. The vulcanizing mold as claimed in claim 8, wherein the core has a multiplicity of apertures, which are filled by the mold material.

12. The vulcanizing mold as claimed in claim 11, wherein the apertures are formed by bores in the core or the core has a grid-like structure, which forms the apertures.

13. The vulcanizing mold as claimed in claim 8, wherein the core has externally formed-on stiffening ribs.

14. A method of forming a vehicle tire, comprising: providing the vulcanizing mold according to claim 1, and manufacturing the vehicle tire using the vulcanizing mold.
